(19) United States
(12) Patent Application Publication
(10) Pub. No.: US 2022/0408876 A1
(43) Pub. Date: Dec. 29, 2022

(54) Combined Leather-Rubber Molded Outsole System and Method

(71) Applicant: Washington Shoe Company, Kent, WA (US)

(72) Inventor: Karl R. Moehring, Seattle, WA (US)

(73) Assignee: Washington Shoe Company, Kent, WA (US)

(21) Appl. No.: 17/903,899

(22) Filed: Sep. 6, 2022

Related U.S. Application Data
(63) Continuation-in-part of application No. 13/944,745, filed on Jul. 17, 2013, now abandoned.
(60) Provisional application No. 61/679,837, filed on Aug. 6, 2012.

(51) Int. Cl. A43B 13/12; A43B 13/06; A43B 13/04; A43B 13/32; A43B 13/30

(52) U.S. Cl. CPC A43B 13/122; A43B 13/06; A43B 13/04; A43B 13/32; A43B 13/30

(57) ABSTRACT

Systems and methods are involved with but are not limited to: placing one or more leather portions in a mold, the mold including a cavity with a cavity shape; placing rubber material in the mold; and applying heat to the one or more leather portions and the rubber material while the one or more leather portions and the rubber material are in the mold and subsequently cooling the one or more leather portions and the rubber material thereby fusing one or more portions of the rubber material to the one or more leather portions and thereby conforming one or more portions of the rubber material to one or more portions of the cavity shape. In addition to the foregoing, other method aspects are described in the claims, drawings, and text forming a part of the present disclosure.

### SUMMARY

In one or more aspects, a system can include a footwear outsole including at least one leather piece including at least one surface portion; and a rubber material including at least one portion, wherein the at least one leather piece and the rubber material are coupled together solely by the at least one portion of the rubber material having been fused under heat directly to the at least one surface portion of the at least one leather piece, the at least one leather piece and the rubber material coupled together without any other coupling involved in addition to having been fused under heat. Wherein the at least one leather piece is free from being coupled to the rubber material by any items from the following list including but not limited to at least one nail, at least one adhesive material, at least one glue material, at least one tack, at least one staple, at least one screw, at least one stitch, at least one tape material, and at least one velcro material. Wherein all surface portions of the at least one leather piece that are coupled to the rubber material are directly coupled to the rubber material without any other material being coupled therebetween. Wherein the at least one leather piece and the rubber material are coupled together without involving any adhesive material. Wherein the at least one portion of the rubber material is coupled in glue-free direct surface contact with the at least one surface portion of the at least one leather piece. Wherein the at least one portion of the rubber material is coupled in direct surface contact with the at least one surface portion of the at least one leather piece. Wherein the at least one leather piece is at least one noncontiguous individually separate leather component. Wherein all the surface portions of the at one leather piece and the rubber material that are in contact with one another are glue-free surfaces. Wherein the rubber material being of one or more materials selected from the following list: pure latex, latex blended with calcium carbonate, latex blended with rice husks, devulcanized recycled waste rubber, thermoplastic rubber, carbon reinforced rubber, or silica reinforced rubber.

In one or more aspects, a system can include a footwear outsole including at least two leather pieces, the at least two leather pieces being spaced from one another with at least one gap between the at least two leather pieces; and at least one portion of rubber material coupled to the at least two leather pieces exclusively by the at least one portion of rubber material and the at least two leather pieces having been thermally molded together with the at least one portion of rubber material being at least positioned in the at least one gap between the at least two leather pieces. Wherein the at least two leather pieces are free from being coupled to the rubber material by any items from the following list including but not limited to at least one nail, at least one adhesive material, at least one tack, at least one staple, at least one screw, at least one stitching, at least one tape piece, and at least one velcro piece. Wherein all surface portions of the at least two leather pieces that are coupled to the at least one portion of the rubber material are directly coupled to the at least one portion of the rubber material without any other material being coupled therebetween. Wherein the at least two leather pieces and the at least one portion of the rubber material are coupled together without contact with any adhesive material. Wherein the at least one portion of the rubber material being of one or more materials selected from the following list: pure latex, latex blended with calcium carbonate, latex blended with rice husks, devulcanized recycled waste rubber, thermoplastic rubber, carbon reinforced rubber, or silica reinforced rubber. Wherein the at least one portion of the rubber material is coupled in glue-free direct surface contact with the at least two leather pieces.

In one or more aspects, a system can include a leather-rubber molded footwear outsole consisting of at least one leather piece; and a rubber material coupled with the at least one leather piece solely by thermal molding. Wherein the at least one leather piece is free from being coupled to the rubber material by any items from the following list including but not limited to at least one nail, at least one adhesive material, at least one tack, at least one staple, at least one screw, at least one stitching, at least one tape piece, and at least one velcro piece. Wherein all surface portions of the at least one leather piece that are coupled to the at least one portion of the rubber material are directly coupled to the rubber material without any other material being coupled therebetween. Wherein the at least two leather pieces and the rubber material are coupled together without contact with any adhesive material. Wherein the rubber material being of one or more materials selected from the following list: pure latex, latex blended with calcium carbonate, latex blended with rice husks, devulcanized recycled waste rubber, thermoplastic rubber, carbon reinforced rubber, or silica reinforced rubber.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise.

With reference now to the figures, shown are one or more examples of combined leather-rubber molded outsole system and method based articles of manufacture, compositions of matter, systems for producing and/or methods for producing same that may provide context, for instance, in introducing one or more processes and/or devices described herein.

FIG. 1 is a perspective view of portions of a combined leather-rubber molded outsole system in a first phase of production.

FIG. 2 is a top plan view of the outsole mold shown as part of the combined leather-rubber molded outsole system of FIG. 1.

FIG. 3 is a side-elevation top plan view of the outsole mold shown as part of the combined leather-rubber molded outsole system of FIG. 1.

FIG. 4 is a perspective view of portions of the combined leather-rubber molded outsole system of FIG. 1 in a second phase of production.

FIG. 5 is a perspective view of portions of the combined leather-rubber molded outsole system of FIG. 1 in a third phase of production.

FIG. 6 is a perspective view of portions of the combined leather-rubber molded outsole system of FIG. 1 in a fourth phase of production.

FIG. 7 is a perspective view of portions of the combined leather-rubber molded outsole system of FIG. 1 in a fifth phase of production.

FIG. 8 is a perspective view of a first phase of a combined leather-rubber molded outsole produced by the combined leather-rubber molded outsole system of FIG. 1.

FIG. 9 is a perspective view of a second phase of a combined leather-rubber molded outsole produced by the combined leather-rubber molded outsole system of FIG. 1.

FIG. 10 is a bottom plan view of an alternative implementation of the combined leather-rubber molded outsole produced by the combined leather-rubber molded outsole system of FIG. 1.

### DETAILED DESCRIPTION

In the following detailed description, reference is made to the accompanying drawings, which form a part hereof. In the drawings, similar symbols typically identify similar components, unless context dictates otherwise. Other embodiments may be utilized, and other changes may be made, without departing from the spirit or scope of the subject matter presented here.

To construct footwear outsoles for footwear (e.g. shoes, boots, sandals, etc.), various forms of separate leather components (e.g. solid-bends, cut soles, built units, etc.), or separate rubber components (e.g. solid sheet, cut soles, built units, insert molded, molded on, etc.) are in some conventional approaches used alone. Other conventional approaches utilize differing properties of leather and rubber components for different outsole exterior surfaces (e.g. ground contact surfaces for contacting floors, sidewalks, earth, etc.) through first separately forming the leather components and the rubber components and then coupling the leather components and the rubber components together using procedures that use one or more additional materials (e.g. coupling using nails, adhesive material, glue material, tacks, staples, screws, stitches, tape material, Velcro material, etc.) in final assembly. Unlike conventional approaches, the combined leather-rubber molded outsole system and method as described and claimed herein does not use any materials in addition to one or more leather pieces and rubber material to couple the one or more leather pieces and the rubber material together. Instead, the combined leather-rubber molded outsole system and method as described and claimed herein uses thermal molding to thermally fuse the rubber material to the one or more leather pieces to thereby couple the rubber material to the one or more leather pieces. Thus, no additional materials such as those found in conventional approaches such as nails, adhesive material, glue material, tacks, staples, screws, stitches, tape material, Velcro material, or any other material in addition to the one or more leather pieces and the rubber material are not used with the combined leather-rubber molded outsole system and method to couple the rubber material to the one or more leather pieces as solely forming the combined leather-rubber molded outsole as described and claimed herein.

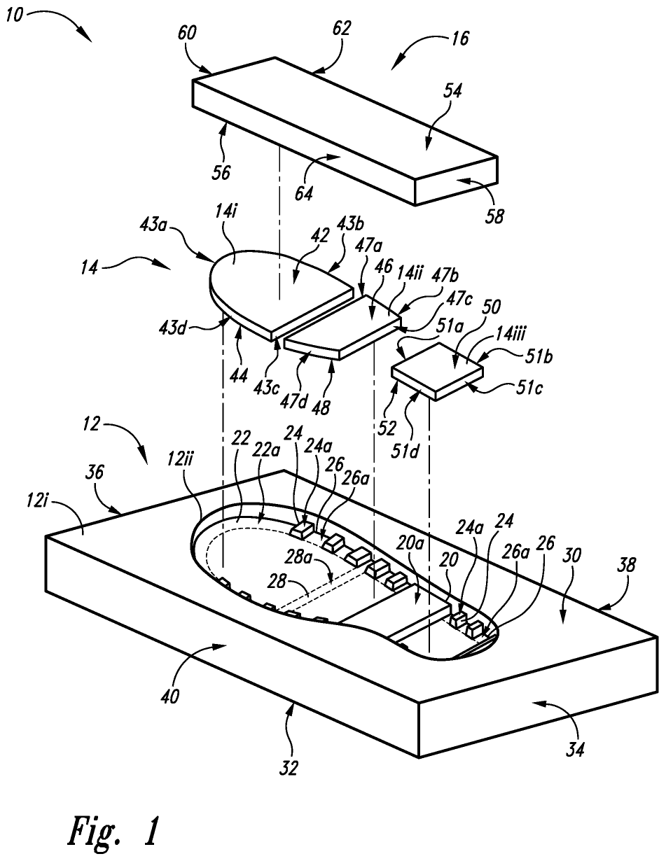

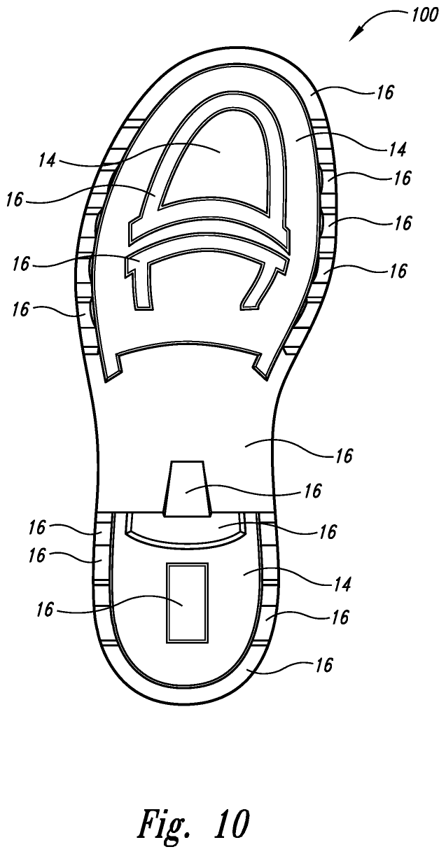

Referring now to FIG. 1, a combined leather-rubber molded outsole system 10 depicted at least in part in FIG. 1 can form without use of any materials in addition to one or more leather pieces and rubber material, through a single molding process, a combined leather-rubber molded outsole (e.g. outsole 100 of FIG. 9, outsole 100 of FIG. 10, etc.) having various rubber and leather exterior contact surfaces (e.g. rubber exterior contact surfaces 20b, 22b, 23b, 24b, 26b, and 28b and leather exterior contact surfaces 44, 48, 52 of FIGS. 8 and 9 further discussed below).

Outsole system 10 is depicted in FIG. 1 in a first phase of a corresponding method to include mold 12 having frame 12i and cavity 12ii (shown with a cavity shape of a footwear outsole) positioned therein, leather assembly 14 having pieces 14i, 14ii, and 14iii, and rubber material 16. Frame 12i includes surfaces 30, 32, 34, 36, 38, and 40 all of which are shown to be free from being contacted by any materials such as nails, adhesive material, glue material (e.g., being “glue-free”), tacks, staples, screws, stitches, tape material, Velcro material, or any other materials so as to be ready to receive the leather assembly 14 and the rubber material 16 without any materials in addition to the leather assembly 14 and the rubber material 16 being involved.

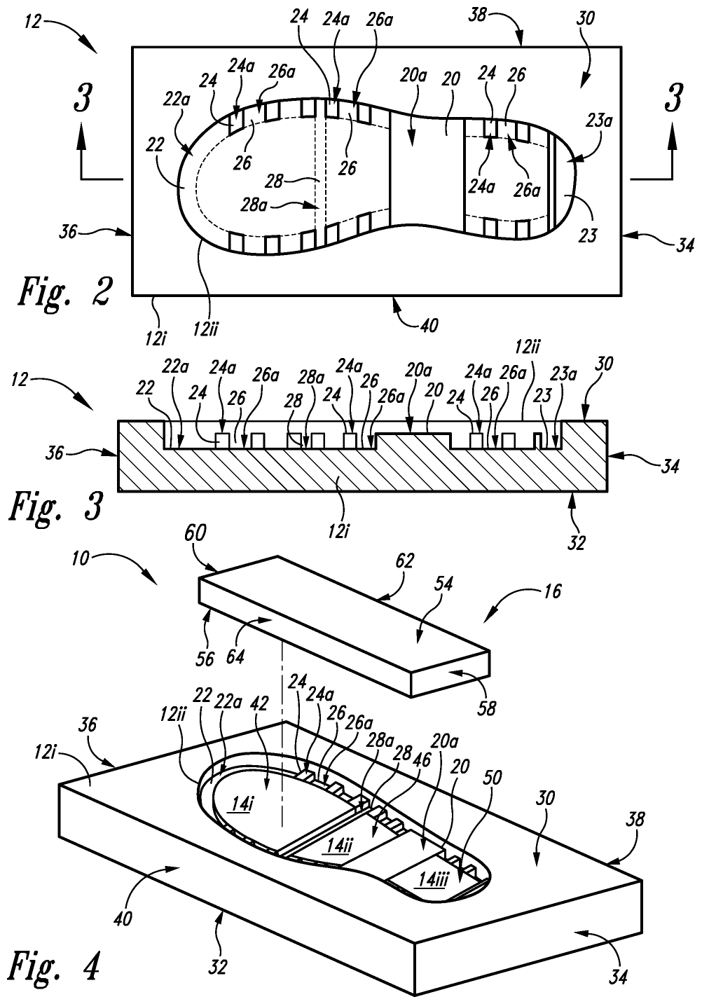

Further illustrated in FIGS. 2 and 3, cavity 12ii includes cavity floor portions including toe portion 22 (shown with front toe edge of the cavity floor) with surface 22a, heel portion 23 with surface 23a, tread portions 26 with surfaces 26a, and mid-portion 28 with surface 28a. Cavity floor portions also include portions shown by dashed line to receive leather pieces 14i, 14ii, and 14iii (e.g. leather pieces with substantially flat surfaces, etc.). Cavity 12ii also includes elevated portions including mid-portion 20 with surface 20a, and tread portions 24 with surface 24a.

Referring again to FIG. 1, leather pieces 14i, 14ii, and 14iii (e.g. cut from sheets) of the leather assembly 14 include surfaces 42, 43a, 43b, 43c, 43d, 44, surfaces 46, 47a, 47b, 47c, 47d, 48, and surfaces 50, 51a, 51b, 51c, 51d, 52, respectively. As shown, all surfaces of the leather assembly 14 are free from being contacted by any materials such as nails, adhesive material, glue material, tacks, staples, screws, stitches, tape material, Velcro material, or any other materials. Rubber material 16 (including surfaces 54, 56, 58, 60, 62, and 64) can be various types such as pure latex, latex blended with calcium carbonate, latex blended with rice husks, devulcanized recycled waste rubber, thermoplastic, carbon or silica reinforced, etc., and being variously shaped such as rectangular sheet, rectangular bar, collection of pieces, etc. As shown, all surfaces of rubber material 16 are free from being contacted by any materials such as nails, adhesive material, glue material, tacks, staples, screws, stitches, tape material, Velcro material, or any other materials. This first method phase of FIG. 1 shows leather assembly 14 and rubber material 16 before being received by cavity 12ii of mold 12.

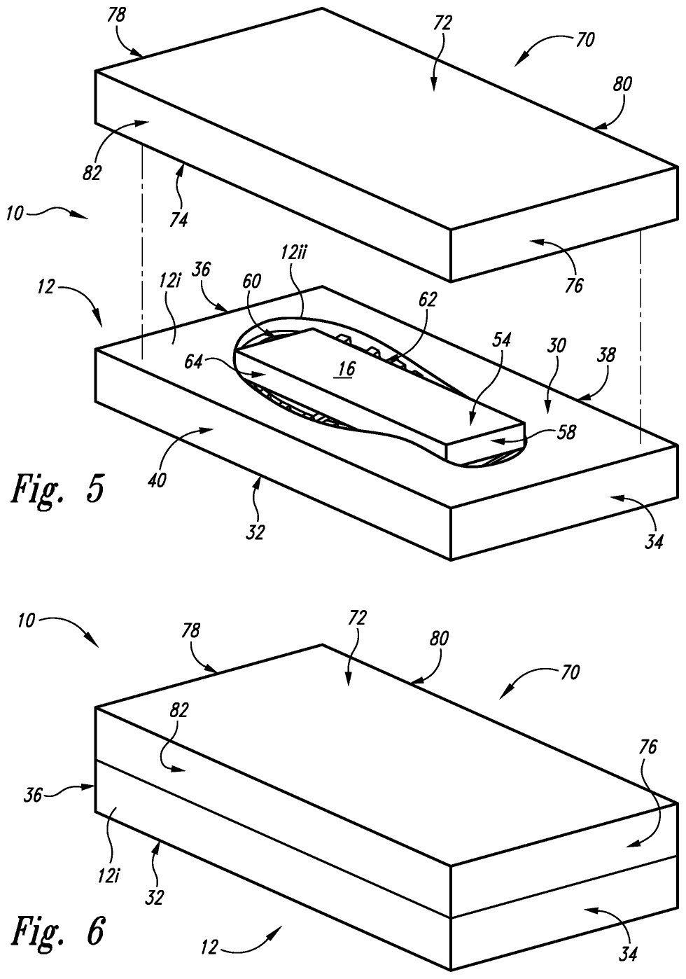

A second phase of the associated method is depicted in FIG. 4 to show leather pieces 14i, 14ii, and 14iii of leather assembly 14 being received by cavity 12ii wherein surfaces 44, 48, 52 (see FIG. 1) of leather pieces 14i, 14ii, and 14iii, respectively, are in direct contact with floor portion surfaces of cavity 12ii. A third phase of the associated method is depicted in FIG. 5 as cavity 12ii is further receiving rubber material 16 wherein surface 56 of rubber material 16 is in direct contact with surfaces 42, 46, and 50 of leather pieces 14i, 14ii, and 14iii, respectively. FIG. 5 further depicts cover 70 having surfaces 72, 74, 76, 78, 80, and 82 all of which are shown to be free being contacted by any materials such as nails, adhesive material, glue material, tacks, staples, screws, stitches, tape material, Velcro material, or any other materials so as to be ready to receive the leather assembly 14 and the rubber material 16 without any materials in addition to the leather assembly 14 and the rubber material 16 being involved.

A fourth phase of the associated method is depicted in FIG. 6 as cover 70 is closed upon mold 12 with heat and in some implementations increased pressure (e.g. substantially above, for instance double or triple, atmospheric pressure found at mold location) being applied to allow rubber material 16 to conform one or more portions of the rubber material to one or more portions of the cavity shape and to otherwise fill in gaps between and above the leather assembly 14 inside the cavity 12ii without any other materials in addition to the leather assembly 14 and the rubber material 16 being involved and thereby fusing the rubber material 16 to the leather assembly 14 forming a one piece outsole 90 as shown in subsequent figures. Shrinkage or expansion of leather assembly 14 may occur so can be taken under consideration in sizing. In some implementations, temperature in a range of 150 to 170 degrees centigrade may be required for fusing to occur.

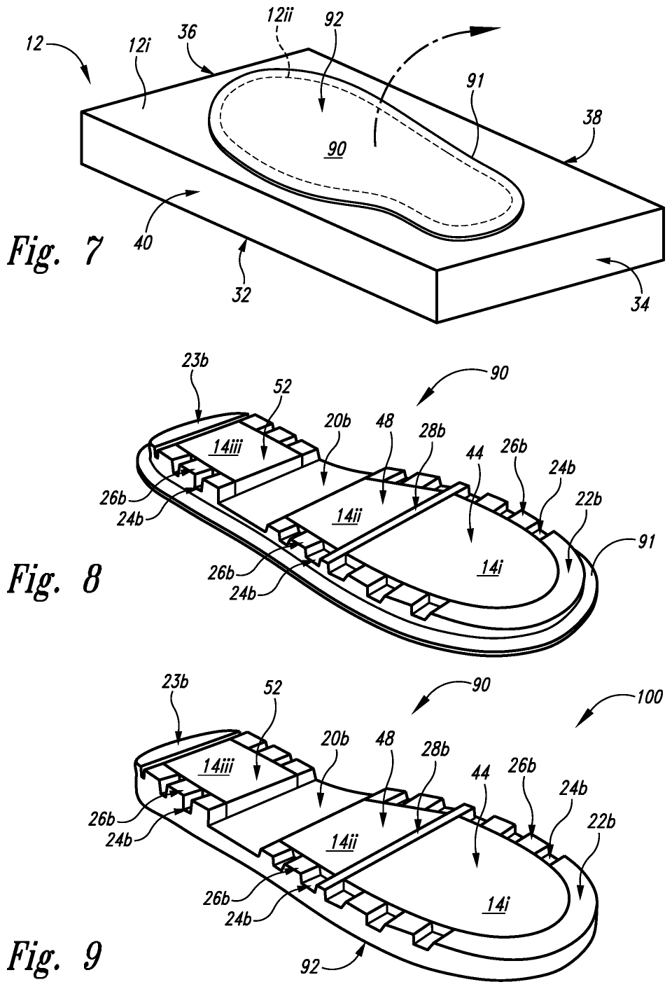

A fifth phase of the associated method is depicted in FIG. 7 after molding showing outsole 90 including rubber interior surface 92 still in cavity 12ii being cooled in an untrimmed state with excess material 91 bordered by dashed line showing outline of cavity 12ii.

A sixth phase of the associated method is depicted in FIG. 8 showing exterior surfaces of untrimmed outsole 90 having exterior surfaces including rubber surfaces 20b (rubber mid-portion and ground contact surface portions), 22b (rubber front toe portion and ground contact surface portions), 23b (rubber back heel portion), 24b (rubber tread portion and ground contact surface portions), 26b (rubber tread portion and ground contact surface portions), and 28b (rubber mid-portion and ground contact surface portions). These exterior rubber surfaces are formed by rubber material 16 in a heated state coming into contacted with surfaces 20a, 22a, 24a, 26a, and 28a of cavity 12ii. The untrimmed outsole is also shown as having exterior surfaces including surfaces 44, 48, and 50 of leather pieces 14i, 14ii, and 14iii, respectively wherein surfaces 44, 48, and 50 are shown as being other than one or more front toe edge surfaces whereas in other implementations, front toe edge surfaces can also be made up of leather surfaces.

A seventh phase of the associated method is depicted in FIG. 9 with outsole 90 as trimmed outsole 100 ready for assembly with an insole and a footwear upper to make a footwear with such outsole 90.

Trimmed outsole 100 is depicted in FIG. 10 having an alternative patterned placement of exterior surfaces for leather assembly 14 and rubber material 16.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

What is claimed is:

1. A footwear outsole comprising:
at least one leather piece including at least one surface portion; and
a rubber material including at least one portion, wherein the at least one leather piece and the rubber material are coupled together solely by the at least one portion of the rubber material having been fused under heat directly to the at least one surface portion of the at least one leather piece, the at least one leather piece and the rubber material coupled together without any other coupling involved in addition to having been fused under heat.

2. The footwear outsole of claim 1 wherein the at least one leather piece is free from being coupled to the rubber material by any items from the following list including but not limited to at least one nail, at least one adhesive material, at least one glue material, at least one tack, at least one staple, at least one screw, at least one stitch, at least one tape material, and at least one velcro material.

3. The footwear outsole of claim 1 wherein all surface portions of the at least one leather piece that are coupled to the rubber material are directly coupled to the rubber material without any other material being coupled therebetween.

4. The footwear outsole of claim 1 wherein the at least one leather piece and the rubber material are coupled together without involving any adhesive material.

5. The footwear outsole of claim 1 wherein the at least one portion of the rubber material is coupled in glue-free direct surface contact with the at least one surface portion of the at least one leather piece.

6. The footwear outsole of claim 1 wherein the at least one portion of the rubber material is coupled in direct surface contact with the at least one surface portion of the at least one leather piece.

7. The footwear outsole of claim 1 wherein the at least one leather piece is at least one noncontiguous individually separate leather component.

8. The footwear outsole of claim 1 wherein all the surface portions of the at one leather piece and all the surface portions of the rubber material that are in contact with one another are glue-free surfaces.

9. The footwear outsole of claim 1 wherein the rubber material being of one or more materials selected from the following list: pure latex, latex blended with calcium carbonate, latex blended with rice husks, devulcanized recycled waste rubber, thermoplastic rubber, carbon reinforced rubber, or silica reinforced rubber.

10. A footwear outsole comprising:
at least two leather pieces, the at least two leather pieces being spaced from one another with at least one gap between the at least two leather pieces; and
at least one portion of rubber material coupled to the at least two leather pieces exclusively by the at least one portion of rubber material and the at least two leather pieces having been thermally molded together with the at least one portion of rubber material being at least positioned in the at least one gap between the at least two leather pieces.

11. The footwear outsole of claim 10 wherein the at least two leather pieces are free from being coupled to the rubber material by any items from the following list including but not limited to at least one nail, at least one adhesive material, at least one tack, at least one staple, at least one screw, at least one stitching, at least one tape piece, and at least one velcro piece.

12. The footwear outsole of claim 10 wherein all surface portions of the at least two leather pieces that are coupled to the at least one portion of the rubber material are directly coupled to the at least one portion of the rubber material without any other material being coupled therebetween.

13. The footwear outsole of claim 10 wherein the at least two leather pieces and the at least one portion of the rubber material are coupled together without contact with any adhesive material.

14. The footwear outsole of claim 10 wherein the at least one portion of the rubber material being of one or more materials selected from the following list: pure latex, latex blended with calcium carbonate, latex blended with rice husks, devulcanized recycled waste rubber, thermoplastic rubber, carbon reinforced rubber, or silica reinforced rubber.

15. The footwear outsole of claim 10 wherein the at least one portion of the rubber material is coupled in glue-free direct surface contact with the at least two leather pieces.

16. A leather-rubber molded footwear outsole consisting of:
at least one leather piece; and
a rubber material coupled with the at least one leather piece solely by thermal molding.

17. The footwear outsole of claim 16 wherein the at least one leather piece is free from being coupled to the rubber material by any items from the following list including but not limited to at least one nail, at least one adhesive material, at least one tack, at least one staple, at least one screw, at least one stitching, at least one tape piece, and at least one velcro piece.

18. The footwear outsole of claim 16 wherein all surface portions of the at least one leather piece that are coupled to the at least one portion of the rubber material are directly coupled to the rubber material without any other material being coupled therebetween.

19. The footwear outsole of claim 16 wherein the at least two leather pieces and the rubber material are coupled together without contact with any adhesive material.

20. The footwear outsole of claim 16 wherein the rubber material being of one or more materials selected from the following list: pure latex, latex blended with calcium carbonate, latex blended with rice husks, devulcanized recycled waste rubber, thermoplastic rubber, carbon reinforced rubber, or silica reinforced rubber.
